(19) United States
(12) Patent Application Publication
(10) Pub. No.: US 2010/0285442 A1
(43) Pub. Date: Nov. 11, 2010

(54) METHOD FOR APTITUDE TEST

(76) Inventor: Ho Cheon RYOO, Seoul (KR)

Correspondence Address: Workman Nydegger;1000 Eagle Gate Tower, 60 East South Temple, Salt Lake City, UT, 84111, US

(21) Appl. No.: 12/775,343

(22) Filed: May 6, 2010

(30) Foreign Application Priority Data
May 7, 2009 (KR) 10-2009-0039849

(51) Int. Cl. G09B 7/00

(52) U.S. Cl. 434/362

(57) ABSTRACT

An embodiment of the present invention provides a method for an aptitude test. The method includes receiving information concerning a request for an aptitude test service from the user terminal using the central server, and providing the aptitude test service to the user terminal using the central server, wherein the aptitude test service includes video content recorded in database.

### CROSS-REFERENCE TO RELATED APPLICATION

This application claims priority to and the benefit of Korean Patent Application No. 10-2009-0039849, filed on May 7, 2009, the entire content of which is incorporated herein by reference.

### BACKGROUND OF THE INVENTION

1. Field of the Invention

The present invention relates to a method for an aptitude test.

2. Description of the Related Art

A wide variety of aptitude test methods, such as intelligence quotient (IQ) tests, emotional quotient (EQ) tests, or career aptitude tests, are presently being developed to analyze a subject's aptitude in various manners.

Existing aptitude test methods are generally classified into a written assessment implemented offline by paper-based testing, and a computerized assessment implemented online practically everywhere whenever a subject intends to perform an aptitude test.

In both cases, however, tests or queries are eventually presented in forms of letter-based documents and each testing involves a considerable number of questions.

The letter-based testing suffers from various drawbacks. For example, in a case where aptitude tests' subjects are younger people, for example, children or teenagers, the subjects who are assessed for aptitude testing are often bored or distracted, which may cause the subjects to withdraw from the aptitude test or the subjects to choose wrong answers. As such, existing methods for aptitude testing may not properly function.

### BRIEF SUMMARY OF THE INVENTION

The present invention provides a method for an aptitude test, which can increase the efficiency of the aptitude test by presenting test questions visualized in video content to a test subject to stimulate the test subject's interest.

Additional aspects and/or advantages of the invention will be set forth in part in the description which follows and, in part, will be obvious from the description, or may be learned by practice of the invention.

In accordance with one aspect of the present invention, there is provided a method for an aptitude test including receiving information concerning a request for an aptitude test service from the user terminal using the central server, and providing the aptitude test service to the user terminal using the central server, wherein the aptitude test service includes video content recorded in database.

In addition, the video content may include individual video content components independently made according to the age and gender of a person.

Further, the video content may include individual video content components independently made according to the type of occupation by one who is engaged in the occupation.

The video content may be made by an entertainer or an announcer.

In addition, the video content may be made by voicing over many characters.

The receiving of the information concerning the request for the aptitude test service may include receiving user information from the user terminal using the central server, receiving information concerning a test type from the user terminal using the central server, and receiving information concerning an acquaintance to be added from the user terminal using the central server.

The user information may include the user's age, gender and type of occupation of interest.

In addition, the information concerning the test type may include at least one of a career aptitude test, a personality test, an IQ test, and an EQ test.

Further, information concerning the acquaintance to be added may include the number of acquaintance to be added and the relationship between the user and the acquaintance.

The relationship between the user and the acquaintance may include at least one of family members, relatives, friends, teachers, seniors, juniors, and superiors.

The receiving of the information concerning the request for the aptitude test service may further include confirming buyer information concerning a buyer who has accessed the central server from the user terminal, and charging the user terminal for the aptitude test service.

The providing of the aptitude test service may include analyzing the user information, the user's selected test type and the user's answer to a question whether or not there is an acquaintance to be added to deduce an analysis result, extracting video content corresponding to the analysis result among multiple video content components stored in the database, and providing the extracted video content to the user terminal.

The analyzing of the user information may include confirming information concerning the user's age and gender, confirming the user's selected test type; and confirming the number of acquaintances to be added and the relationship between the user and the acquaintances to deduce the analysis result.

In addition, the analyzing of the user information may further include the central server confirming the type of occupation desired by the user to deduce the analysis result.

The extracting of the video content may include extracting the video content to which only the user can answer.

In addition, the extracting of the video content may include extracting the video content to which both the user and the acquaintance can answer.

Further, the extracting of the video content may include extracting multiple video content components to which the user and the acquaintance can independently answer.

The providing of the aptitude test service may include receiving the user's answers to questions visualized in the extracted video content from the user terminal or receiving the user's and the acquaintance's answers using the central server.

In addition, the providing of the aptitude test service may include the central server providing aptitude test results to the user terminal based on the user's answers or the acquaintance's answers.

Further, the providing of the aptitude test results may include providing the aptitude test result based on the user's answers and the aptitude test result based on the acquaintance's answers, respectively.

The user terminal may be a computer, a mobile phone, or an IP-TV.

As described above, in the method for aptitude test according to an embodiment of the present invention, video content of visualized test questions is provided to a test subject to stimulate the test subject's interest, thereby ultimately increasing the efficiency of the aptitude test.

In addition, since not only the test subject but also the subject's acquaintance are allowed to participate in the aptitude test, the subject's self-assessment result of the aptitude test can be compared with the acquaintance's assessment of the subject's aptitude, thereby effectively enhancing the objectivity of the aptitude test.

Further, since the video content is made in various manners according to subject's personal information, the aptitude test adapted to the subject can be performed, thereby increasing the efficiency of the aptitude test.

In addition, since the video content is made by one who is engaged in the relevant occupation or similar occupation fields and when the subject intends to perform the aptitude test, the video content made by one who is engaged in the relevant occupation is provided to the subject, thereby enhancing the subject's interest and involvement in the aptitude test service.

### BRIEF DESCRIPTION OF THE DRAWINGS

The objects, features and advantages of the present invention will be more apparent from the following detailed description in conjunction with the accompanying drawings, in which:

FIG. 1 is a schematic diagram of a system for implementing a method for an aptitude test according to an embodiment of the present invention;

FIG. 2 is a flowchart illustrating the method for aptitude test according to an embodiment of the present invention;

FIG. 3 illustrates an operation of receiving user information in the method for aptitude test according to an embodiment of the present invention;

FIG. 4 illustrates an operation of visualizing the question regarding whether or not user's acquaintance is to be added in the method for aptitude test according to an embodiment of the present invention;

FIG. 5 illustrates video content instances in the method for aptitude test according to an embodiment of the present invention;

FIG. 6 illustrates an operation of providing video content in the method for aptitude test according to an embodiment of the present invention;

FIG. 7 illustrates an operation of receiving user's answers in the method for aptitude test according to an embodiment of the present invention; and

FIGS. 8 through 10 illustrate an operation of providing aptitude test results in the method for the aptitude test according to an embodiment of the present invention.

### DETAILED DESCRIPTION OF THE INVENTION

Reference will now be made in detail to the present embodiments of the present invention, examples of which are illustrated in the accompanying drawings. Aspects, advantages and features of the present invention and methods of accomplishing the same may be understood more readily by reference to the following detailed description of exemplary embodiments and the accompanying drawings. Like reference numerals refer to like elements throughout the specification.

Hereinafter, embodiments of the present invention will be described in detail with reference to the accompanying drawings.

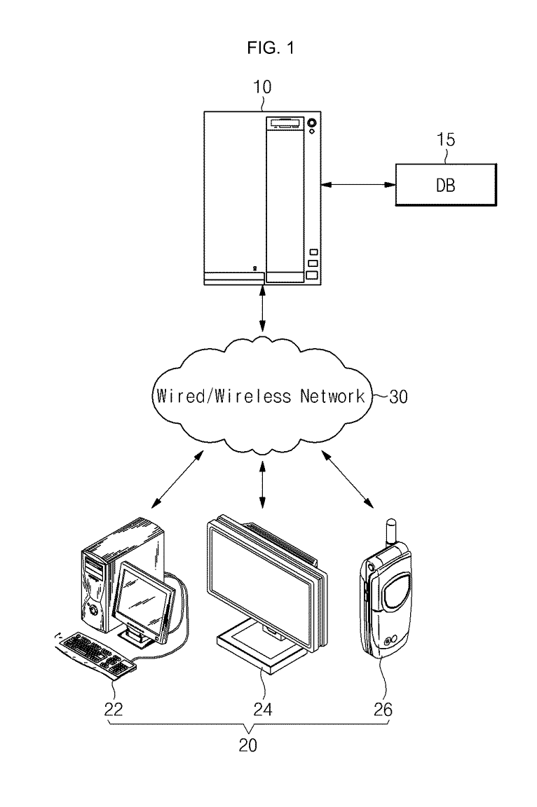

FIG. 1 is a schematic diagram of a system for implementing a method for an aptitude test according to an exemplary embodiment of the present invention.

Referring to FIG. 1, the system includes a central server 10, a user terminal 20, and a wired/wireless network 30 connecting the central server 10 and the user terminal 20.

Representative examples of the user terminal 20 may include a computer 22, an IP-TV 24, a cellular phone 26, and the like. The wired/wireless network 30 may be, for example, the Internet.

The central server 10 is connected by the wired/wireless network 30. The central server 10 includes database 15 having information pertaining to aptitude test service and members' data recorded therein. In addition, the central server 10 may provide the aptitude test service in different manners according to user terminal 20. For example, if the computer 22 or the cellular phone 26 is used as the user terminal 20, the aptitude test service may be implemented through a website configured to optimize the same to the computer 22 or the cellular phone 26. If the IP-TV 24 is used as the user terminal 20, the aptitude test service may be implemented through a broadcasting site for IP-TVs configured to enable interactive communications. Here, the aptitude test service includes providing video content visualizing the aptitude test service, and providing an aptitude test result. More specifically, the aptitude test service means a series of services that the central server 10 provides to the user terminal 20, including operations of confirming buyer information and providing the result of the aptitude test.

In the following description, the method for an aptitude test according to an embodiment of the present invention will be described with regard to the computer 22, which is most commonly used as the user terminal 20, by way of example, but not limited thereto. Of course, the method for aptitude test according an embodiment of the present invention can also be applied to the cellular phone 26 or the IP-TV 24.

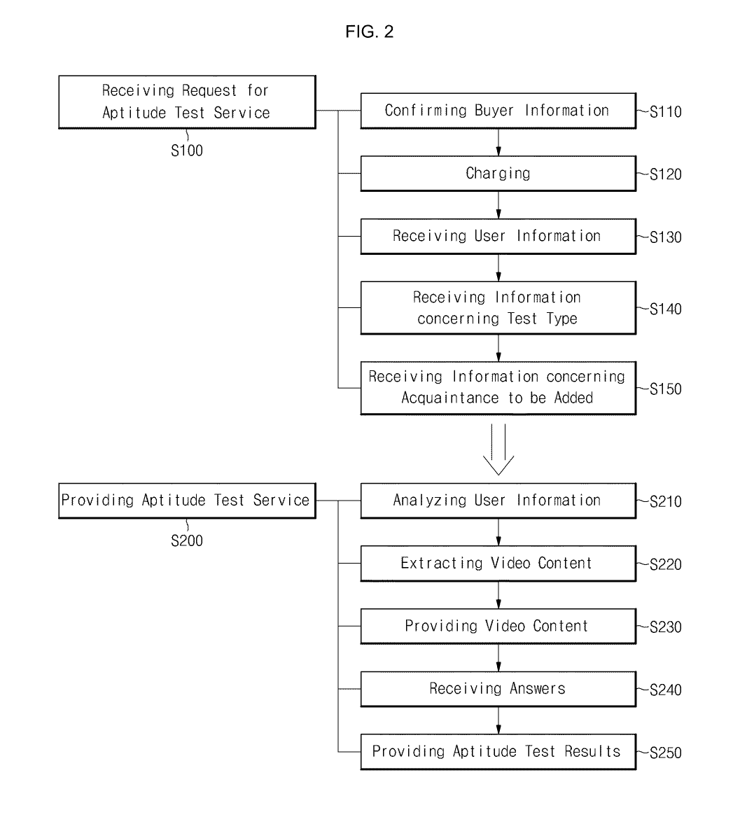

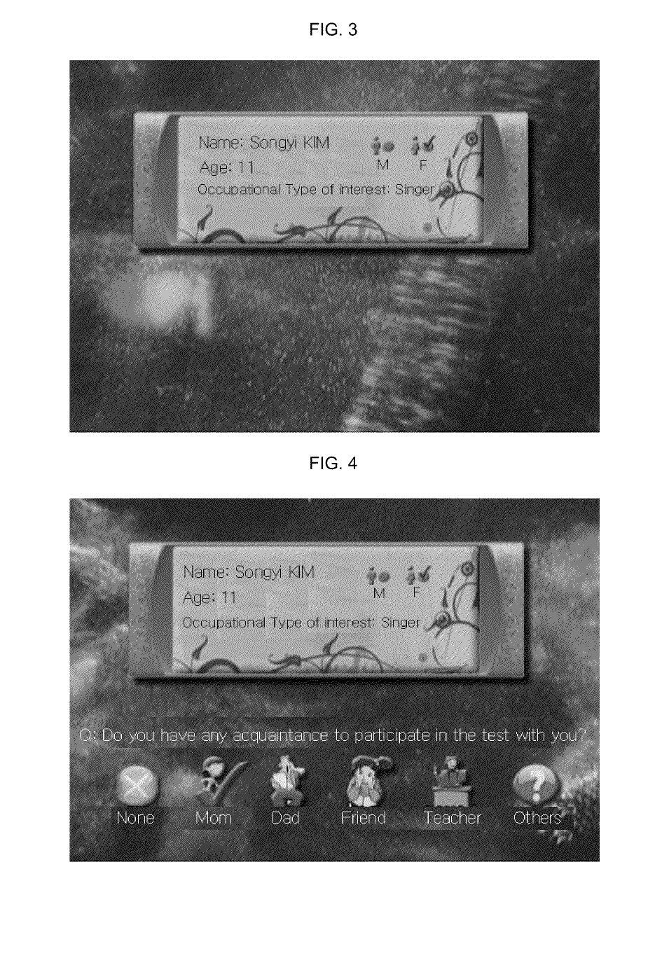

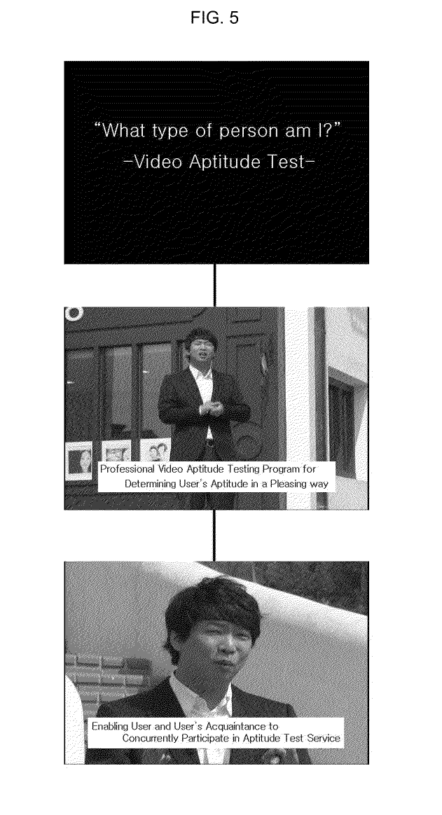

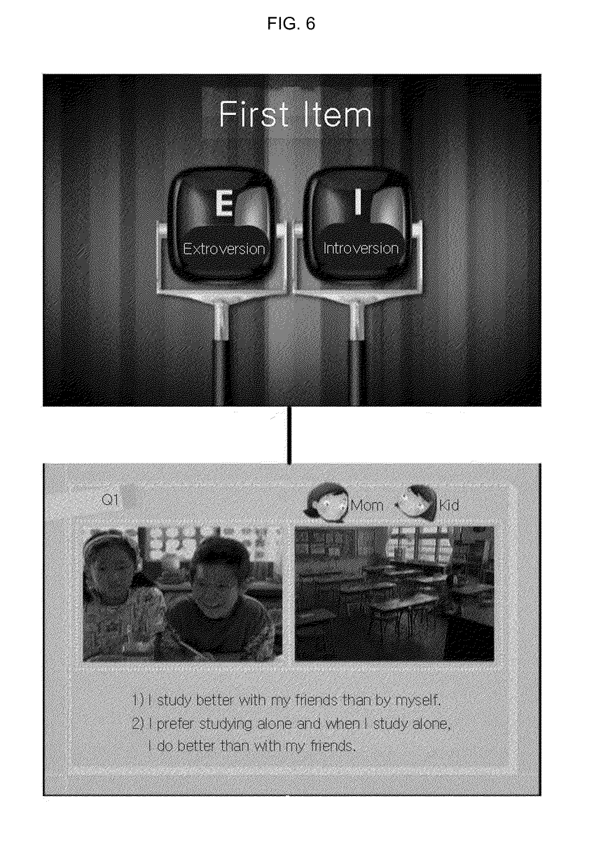

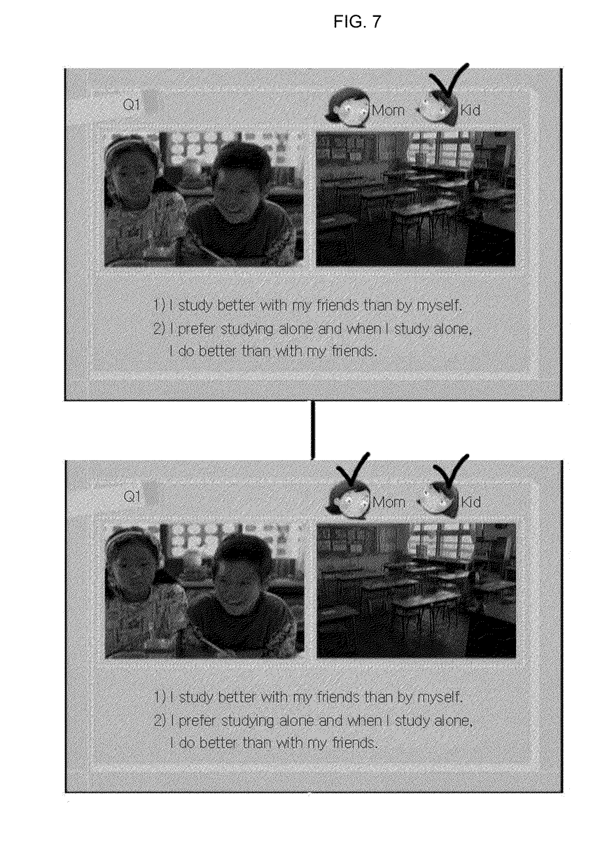

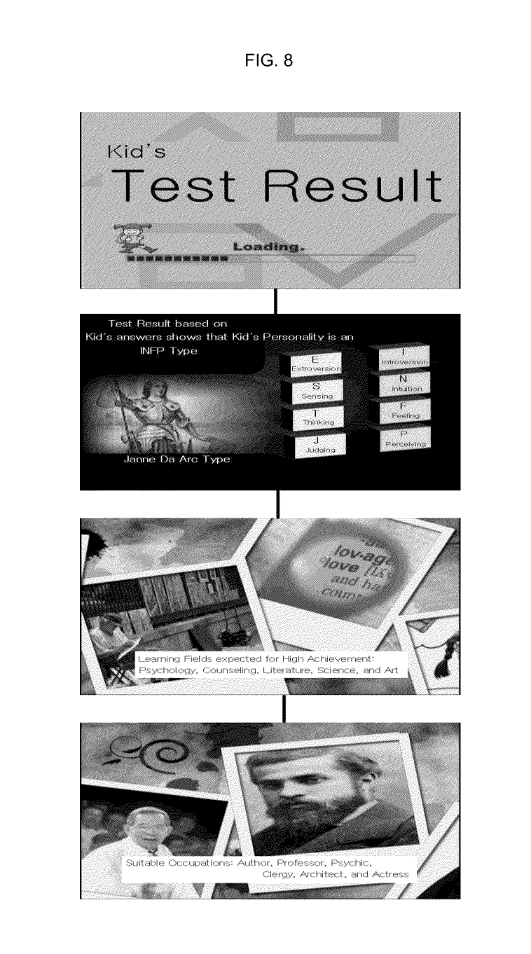

FIG. 2 is a flowchart illustrating a method for an aptitude test according to an embodiment of the present invention. FIG. 3 illustrates an operation of receiving user information in the method for an aptitude test according to an embodiment of the present invention. FIG. 4 illustrates an operation of visualizing the question regarding whether or not user's acquaintance is to be added in the method for an aptitude test according to an embodiment of the present invention. FIG. 5 illustrates video content instances in the method for an aptitude test according to an embodiment of the present invention. FIG. 6 illustrates an operation of providing video content in the method for an aptitude test according to an embodiment of the present invention. FIG. 7 illustrates an operation of receiving user's answers in the method for an aptitude test according to an embodiment of the present invention. FIGS. 8 through 10 illustrate an operation of providing a user with an aptitude test result in the method for an aptitude test according to an embodiment of the present invention.

In the following description, the method for an aptitude test according to an embodiment of the present invention will be described from the standpoint of a central server as an aptitude test service provider.

Referring to FIG. 2, the method for an aptitude test according to an embodiment of the present invention includes operations of receiving a request for an aptitude test service from a user (S100) and providing the user with the aptitude test service (S200). In operation S200, user information, test type, acquaintance(s) to be added, and so on, are analyzed to extract video content appropriate for the user and the extracted video content is provided to a user terminal. In the method for an aptitude test according to an embodiment of the present invention, the video content of visualized test questions is provided to a test subject to stimulate the test subject's interest, thereby increasing the efficiency of the aptitude test.

In operation S100, the central server receives requests for aptitude tests from user terminals. More specifically, operation S100 includes confirming buyer information (S110), charging (S120), receiving user information (S130), receiving information concerning a test type (S140), and receiving information concerning acquaintance(s) to be added (S150).

In operation S110, the central server confirms buyer information concerning a buyer who has accessed the central server from the user terminal. More specifically, in operation s110, when the user terminal accesses the central server to input buyer's personal information in order to purchase aptitude test service through a website, the central server confirms the buyer's personal information for registration with the website to allow the buyer to use the aptitude test service provided through the website. The buyer's personal information may include buyer's name, resident registration number, email address, mobile phone number, and so on. As described above, in operation S110, the buyer information is received to approve website registration to a buyer who has accessed the central server for the first time. However, once the buyer has registered in the central server, he/she can directly log on by entering his/her ID and password without a registration process.

The foregoing description has been made in a case where the user terminal is a computer by way of example. Alternatively, in a case where the user terminal is an IP-TV, the buyer information can be immediately confirmed such that the central server authenticates a set-top box (STB) when the buyer accessed the central server to purchase the aptitude test service.

Here, it is noted that the terms “buyer” and “user” used herein are to be construed to have different concepts. That is to say, the user means a subject of the aptitude test, and the buyer means one who accesses the central server to use the aptitude test service. For a better understanding, consider the subject of the aptitude test may include infants, kids or teenagers such as elementary or high school students, and so on. Then, the buyer may include the subject's parent who initially accesses the central server to make payment for the aptitude test service. However, the user may be the buyer, and the buyer may also be the user.

In operation S120, the central server charges the user terminal for the aptitude test service. The charging may be performed by a credit card or automatic withdrawal, as commonly used in the Internet-based electronic commerce. In a case where the user terminal is an IP-TV, in addition to the charge for the IP-TV service, the cost for the aptitude test service may be additionally charged.

In operation S130, the central server receives user information about a user who actually uses the aptitude test service from the user terminal. As shown in FIG. 3, the user information may include user's gender, age, occupation of interest, and so on. However, the user information may vary according to the type of the aptitude test. In such aptitude tests as Myers-Briggs Type Indicator (MBTI) testing, the user information may include gender and age only. However, in career aptitude tests, the user information may essentially include occupation of interest. When the central server provides the user terminal with an aptitude test service including video content, the video content may vary according to the user information. Accordingly, the user information is an important factor to present the video content concerning the user among multiple video content components stored in the database.

In operation S140, the central server receives information about the type of the aptitude test from the user terminal. In more detail, the type of the aptitude test includes a wide variety of types, including a career aptitude test, a personality test, an IQ test, an EQ test, an MBTI test, and so on. Therefore, in operation S140, the central server receives from the user terminal user's desired type of aptitude test for the user terminal to provide later the aptitude test service having the test type received from the user terminal.

In operation S150, the central server asks a question of whether there is any acquaintance to be added or not to the user terminal, and receives the information about the presence or absence of the acquaintance to be added from the user terminal. In operation S150, the user's acquaintance who intends to use the aptitude test service together with the user may be added. The central server asks questions about the number of acquaintance(s) to be added and the relationship between the user and the acquaintance(s) to the user terminal and receives the answers to the questions from the user terminal.

As shown in FIG. 4, from the standpoint of the user, the relationship between the user and the acquaintance may include mom, dad, friend, and teacher, and other acquaintances may include user's seniors, juniors, superiors, and so on. The user may select two or more acquaintances. When the central server provides the user terminal with the aptitude test service including video content upon the user adding the acquaintance, a web page or video content made for the user or the acquaintance to answer the questions is provided to the user terminal. In the method for an aptitude test according to an embodiment of the present invention, since not only the test subject (user) but also the acquaintance participate in the aptitude test, the subject's self-assessment result of the aptitude test can be compared with the acquaintance's assessment of the subject's aptitude, thereby effectively enhancing the objectivity of the aptitude test.

In operation S200, the central server provides the user terminal with the aptitude test service including video content. More concretely, operation S200 may include analyzing user information (S210), extracting video content (S220), providing video content (S230), receiving answers (S240) and providing aptitude test results (S250).

As shown in FIG. 5, the video content may be made such that questions asked in the aptitude test are prepared by professionals in various occupation fields, including entertainers, announcers, and others. The video content may also be made by voicing over many characters. Therefore, the user is allowed to perform the aptitude test in quite an active manner and the participant (i.e., the user) gets more interested in the aptitude test. In addition, the video content may include background images of a wide variety of themes. That is to say, various kinds of background images including natural surroundings, sports and movies, or famous entertainers or characters so beloved by infants, kids or teenagers, are inserted into the video content, making the user find out the aptitude test very exciting and inducing curiosity about the aptitude test to the user. Accordingly, since there is no dull moment for the duration of the aptitude test, the user may be barely distracted in performing the aptitude test. In other words, the user's interest is excited using the visualized, voiced-over video content, making the user actively participate in the aptitude test, thereby increasing the efficiency of the aptitude test.

Even the same video content may be made in different manners according to the user's age and gender. To the same question in, for example, the MBTI test given by an infant aged 6 and a teenager aged 15, the answers may be different because test takers' levels of vocabulary and language understanding are different and answering methods, backgrounds, icons, or characters included in the video content may be differently presented. For example, an appropriate answering method for the infant aged 6 may be “Do you like to be with your friends, or do you like being alone?” An appropriate answering method for the teenager aged 15 may be “Do you like to get along with your friends?” That is to say, since the video content may be made in various manners according to the test subject's personal information, the aptitude test can be performed to be adapted to the level of the subject, thereby increasing the efficiency of the aptitude test.

In addition, in a case of the video content for career aptitude tests, various video content components by the type of occupation may be made by one who is engaged in the relevant occupation or similar fields of occupation. Therefore, when a user intends to be assessed for aptitude testing whether he/she has an aptitude in the occupation of interest, the video content made by one who is engaged in the relevant occupation or similar fields of occupation is provided to the user, thereby enhancing the subject's interest and involvement in the aptitude test service.

In operation S210, the central server analyzes the user information, the user's selected test type, and the answer to the question about the presence of acquaintance added and the analysis result is deduced. Operation S210 may include the central server confirming information about user's age, gender, and type of occupation of interest, the central server confirming information about the user's selected test type, and the central server confirming the answer to the question about the presence of acquaintance added, that is, information about the number of acquaintance(s) to be added and the relationship between the user and the added acquaintance(s). Through these operations, the central server deduces the analysis result for the video content to be provided to the user.

In operation S220, the central server extracts the video content corresponding to the analysis result of the user information among multiple video content components stored in the database. Therefore, the user's age and gender and the test type are comprehensively analyzed to then extract the video content component that is most appropriate to the user. Here, in a case where only the user requests for the aptitude test, a video content component to which only the user can answer is extracted. In a case where the user and his/her acquaintance concurrently participate in the aptitude test, a video content component to which both the user and the acquaintance can answer or video content components to which the user and the acquaintance can independently answer, may be extracted.

In operation S230, the central server provides the user terminal with an aptitude test service including the extracted video content component. In the video content instance, as shown in FIG. 6, a question of the aptitude test is generally conveyed by letters or voice. In this case, the user's interest in the aptitude test can be stimulated and the user can be motivated to actively participate in the aptitude test. As displayed on the lower video content instance shown in FIG. 6, including questions 1) and 2), for example, a background image showing two students studying together can be displayed to suitably reflect the question 1), and a background image showing a student sitting all alone in an empty classroom can be displayed to suitably reflect the question 2).

In addition, “mom” and “kid” character icons are positioned at the top of the right side of the screen displayed, suggesting that the user selected “mom” as the acquaintance to be added to the aptitude test. As described above, in terms of the relationship between the user and the acquaintance, there may be other relationship options, including, family members, relatives, friends, teachers, seniors, juniors, superiors, and so on, in addition to mom. Here, multiple acquaintances may also be selected. Of course, if the user did not add the acquaintance in operation S130 of receiving the user information, only the user proceeds with the aptitude test.

In operation S240, user's answers or user's and acquaintance's answers to the questions included in the video content component extracted by the central server are received. Referring to FIG. 7, a “kid” character icon is displayed in color in the upper video content instance, and both “kid” and “mom” character icons are displayed with a check mark in the lower video content instance. Once the user or the user's acquaintance completes answering, the corresponding character icon is displayed with a check mark. Once both the user and the user's acquaintance complete answering, the process is moved on to the next question.

The extracted video content component to which only the user can answer or both the user and the user's acquaintance can answer may be provided, as described above. Alternatively, multiple video content components to which the user and the user's acquaintance can independently answer may be provided separately.

In operation S250, the central server provides the aptitude test results to the user terminal based on the user's answers or the user's and the acquaintance's answers. In this stage, the aptitude test result based on the user's answers and the aptitude test result based on the acquaintance's answers may be provided, respectively.

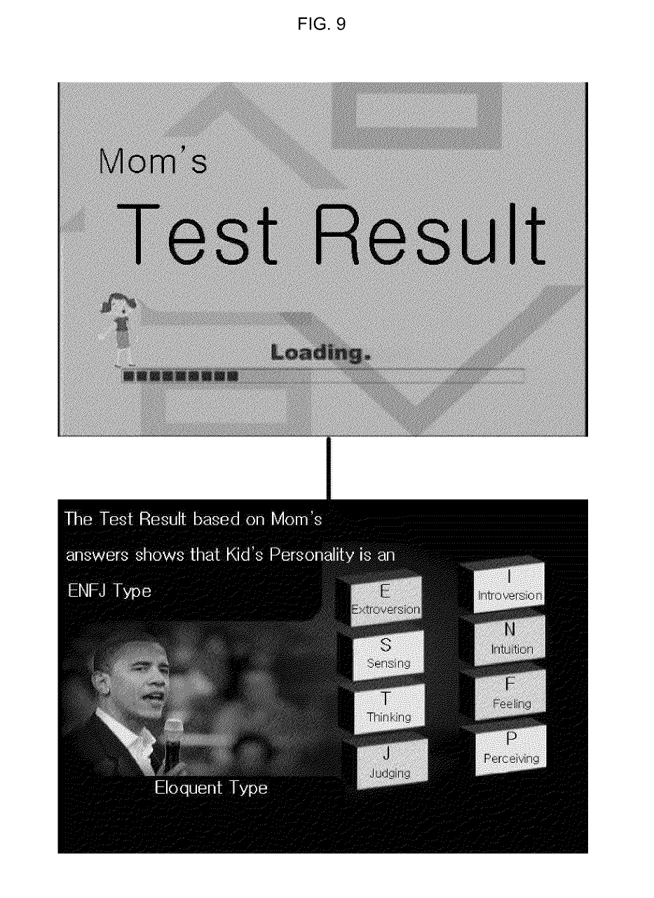

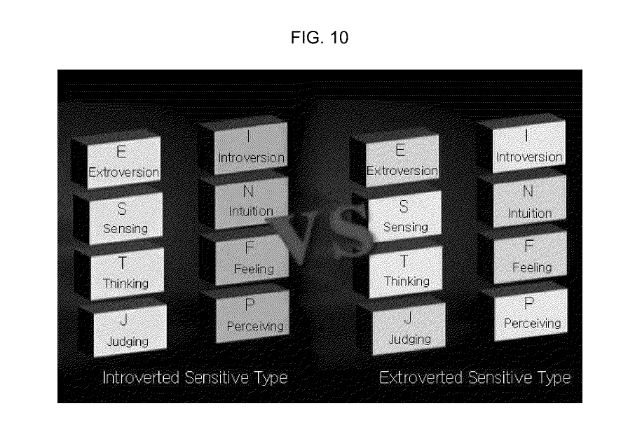

Referring to FIGS. 8 through 10, an operation of providing the user with the aptitude test result is illustrated. Specifically, FIG. 8 illustrates the aptitude test result for a kid (user) and illustrates which type of learning or career fits the user. As shown in FIG. 8, video content may include a pictographic or photographic image concerning the relevant learning or career, thereby allowing the user (even a little kid) to easily access the aptitude test result and to remember the video content for long by stimulating association with letters, pictures (or photos), voice, and so on. For example, as displayed on the third video content instance shown in FIG. 8, a photo of a street painter is presented to describe a career field “Artist.” As displayed on the fourth video content instance shown in FIG. 8, a photo of Cardinal Suhwan KIM is presented to describe a career field “Sacred Profession.” FIG. 9 illustrates the aptitude test result for the user from the standpoint of the user's acquaintance (e.g., mom), and FIG. 10 illustrates the result of user's self-assessment of his/her own aptitude compared with the acquaintance's assessment of the user's aptitude.

As described above, according to the method for an aptitude test according to an embodiment of the present invention, since not only the test subject (user) but also the subject's acquaintance participate in the aptitude test, the subject's self-assessment result of the aptitude test can be compared with the acquaintance's assessment of the subject's aptitude, thereby effectively enhancing the objectivity of the aptitude test.

While exemplary embodiments of the invention have been described in detail hereinabove with reference to the accompanying drawings, it will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for an aptitude test implemented using a central server and a user terminal, the central server connected via a wired/wireless network and including database, and the user terminal connected to the central server, the method comprising:
receiving information concerning a request for an aptitude test service from the user terminal using the central server; and
providing the aptitude test service to the user terminal using the central server,
wherein the aptitude test service includes video content recorded in database.

2. The method of claim 1, wherein the video content includes individual video content components independently made according to the age and gender of a person.

3. The method of claim 1, wherein the video content includes individual video content components independently made according to the type of occupation by one who is engaged in the occupation.

4. The method of claim 1, wherein the video content is made by an entertainer or an announcer.

5. The method of claim 1, wherein the video content is made by voicing over many characters.

6. The method of claim 1, wherein the receiving of the information concerning the request for the aptitude test service comprises:
receiving user information from the user terminal using the central server;
receiving information concerning a test type from the user terminal using the central server; and
receiving information concerning an acquaintance to be added from the user terminal using the central server.

7. The method of claim 6, wherein the user information includes the user's age, gender and type of occupation of interest.

8. The method of claim 6, wherein the information concerning the test type includes at least one of a career aptitude test, a personality test, an IQ test, and an EQ test.

9. The method of claim 6, wherein the information concerning the acquaintance to be added includes the number of acquaintance to be added and the relationship between the user and the acquaintance.

10. The method of claim 9, wherein the relationship between the user and the acquaintance includes at least one of family members, relatives, friends, teachers, seniors, juniors, and superiors.

11. The method of claim 6, wherein the receiving of the information concerning the request for the aptitude test service further comprises:
confirming buyer information concerning a buyer who has accessed the central server from the user terminal; and
charging the user terminal for the aptitude test service.

12. The method of claim 6, wherein the providing of the aptitude test service comprises:
analyzing the user information, the user's selected test type and the user's answer to a question whether or not there is an acquaintance to be added to deduce an analysis result;
extracting video content corresponding to the analysis result among multiple video content components stored in the database; and
providing the extracted video content to the user terminal.

13. The method of claim 12, wherein the analyzing of the user information comprises:
confirming information concerning the user's age and gender;
confirming the user's selected test type; and
confirming the number of acquaintances to be added and the relationship between the user and the acquaintances to deduce the analysis result.

14. The method of claim 13, wherein the analyzing of the user information further comprises the central server confirming the type of occupation desired by the user to deduce the analysis result.

15. The method of claim 13, wherein the extracting of the video content comprises extracting the video content to which only the user can answer.

16. The method of claim 13, wherein the extracting of the video content comprises extracting the video content to which both the user and the acquaintance can answer.

17. The method of claim 13, wherein the extracting of the video content comprises extracting multiple video content components to which the user and the acquaintance can independently answer.

18. The method of claim 12, wherein the providing of the aptitude test service comprises receiving the user's answers to questions visualized in the extracted video content from the user terminal or receiving the user's and the acquaintance's answers using the central server.

19. The method of claim 18, wherein the providing of the aptitude test service comprises the central server providing aptitude test results to the user terminal based on the user's answers or the acquaintance's answers.

20. The method of claim 19, wherein the providing of the aptitude test results comprises providing the aptitude test result based on the user's answers and the aptitude test result based on the acquaintance's answers, respectively.

21. The method of claim 1, wherein the user terminal is a computer, a mobile phone, or an IP-TV.
